(19) United States
(12) Patent Application Publication
(10) Pub. No.: US 2023/0197930 A1
(43) Pub. Date: Jun. 22, 2023

(54) HIGH NICKEL CONTENT POSITIVE ELECTRODES HAVING IMPROVED THERMAL STABILITY

(71) Applicant: GM GLOBAL TECHNOLOGY OPERATIONS LLC, Detroit, MI (US)

(72) Inventors: Bradley R. FRIEBERG, Farmington Hills, MI (US); Xiaosong HUANG, Novi, MI (US); Mark W. VERBRUGGE, Troy, MI (US)

(73) Assignee: GM GLOBAL TECHNOLOGY OPERATIONS LLC, Detroit, MI (US)

(21) Appl. No.: 17/552,533

(22) Filed: Dec. 16, 2021

(51) Int. Cl. H01M 4/36; H01M 10/0525; H01M 10/0569; H01M 10/0568; H01M 4/04; H01M 4/525; H01M 4/505; H01M 4/58; H01M 4/62

(52) U.S. Cl. CPC H01M 4/364; H01M 10/0525; H01M 10/0569; H01M 10/0568; H01M 4/0404; H01M 4/0471; H01M 4/525; H01M 4/505; H01M 4/5825; H01M 4/625; H01M 4/622; H01M 2300/0028; H01M 2004/028

(57) ABSTRACT

An electrode for an electrochemical cell includes a positive electroactive material and a polymeric binder. The positive electroactive material is present in an amount greater than 95 weight percent of the electrode. The positive electroactive material includes first, second, and third electroactive materials. The first electroactive material includes a lithium nickel manganese cobalt oxide (NMC), a lithium nickel manganese cobalt aluminum oxide (NMCA), a lithiated nickel cobalt aluminate (NCA), or a combination thereof. The first electroactive material has a nickel content of greater than or equal to about 60 mole percent. The second electroactive material includes a phosphate-containing positive electroactive material. The third electroactive material includes a lithium manganese oxide (LMO). In certain aspects, the second electroactive material includes a lithium iron phosphate (LFP), a lithium manganese iron phosphate (LMFP), lithium vanadium phosphate (LVP), a transition metal doped lithium vanadium phosphate (LVMP), lithium vanadium fluorophosphate (LVPF), or a combination thereof.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to high nickel content positive electrodes having improved thermal stability.

High-energy density, electrochemical cells, such as lithium-ion batteries can be used in a variety of consumer products and vehicles, such as Hybrid Electric Vehicles (HEVs) and Electric Vehicles (EVs). Typical lithium-ion and lithium sulfur batteries include a first electrode, a second electrode, an electrolyte material, and a separator. One electrode serves as a positive electrode or cathode and another serves as a negative electrode or anode. A stack of battery cells may be electrically connected to increase overall output. Conventional rechargeable lithium-ion batteries operate by reversibly passing lithium-ions back and forth between the negative electrode and the positive electrode. A separator and an electrolyte may be disposed between the negative and positive electrodes. The electrolyte is suitable for conducting lithium-ions and may be in solid (e.g., solid state diffusion), gel, or liquid form. Lithium-ions move from a cathode (positive electrode) to an anode (negative electrode) during charging of the battery, and in the opposite direction when discharging the battery.

Many different materials may be used to create components for a lithium-ion battery. Common negative electrode materials include lithium insertion materials or alloy host materials, like carbon-based materials, such as lithium-graphite intercalation compounds, or lithium-silicon compounds, lithium-tin alloys, and lithium titanate Li₄₊ₓTi₅O₁₂, where 0≤x≤3, such as Li₄Ti₅O₁₂ (LTO). Where the negative electrode is made of metallic lithium, the electrochemical cell is considered a lithium metal battery or cell. Metallic lithium for use in the negative electrode of a rechargeable battery has various potential advantages, including having the highest theoretical capacity and lowest electrochemical potential. Thus, batteries incorporating lithium metal anodes can have a higher energy density that can potentially double storage capacity, so that the battery may be half the size, but still last the same amount of time as other lithium ion batteries. Thus, lithium metal batteries are one of the most promising candidates for high energy storage systems. However, lithium metal batteries also have potential downsides, including possibly exhibiting unreliable or diminished performance and potential premature electrochemical cell failure.

### SUMMARY

In various aspects, the present disclosure provides an electrode for an electrochemical cell. The electrode includes a positive electroactive material and a polymeric binder. The positive electroactive material is present in an amount greater than 95 weight percent of the electrode. The positive electroactive material includes a first electroactive material, a second electroactive material, and a third electroactive material. The first electroactive material includes a lithium nickel manganese cobalt oxide (NMC), a lithium nickel manganese cobalt aluminum oxide (NMCA), a lithiated nickel cobalt aluminate (NCA), or a combination thereof. The first electroactive material has a nickel content of greater than or equal to about 60 mole percent. The second electroactive material may include a phosphate-containing positive electroactive material. The third electroactive material includes a lithium manganese oxide (LMO).

In one aspect, the phosphate-containing positive electroactive material includes a lithium iron phosphate (LFP), a lithium manganese iron phosphate (LMFP), lithium vanadium phosphate (LVP), a transition metal doped lithium vanadium phosphate (LVMP), lithium vanadium fluorophosphate (LVPF), or a combination thereof.

In one aspect, the first electroactive material is present in the positive electroactive material in an amount greater than or equal to about 33 weight percent to less than or equal to about 94 weight percent.

In one aspect, the second electroactive material is present in the positive electroactive material in an amount greater than or equal to about 2 weight percent to less than or equal to about 33 weight percent.

In one aspect, the third electroactive material is present in the positive electroactive material in an amount greater than or equal to about 2 weight percent to less than or equal to about 33 weight percent.

In one aspect, the positive electroactive material further includes an electrically-conductive material.

In one aspect, the electrically-conductive material is present in the electrode in an amount greater than or equal to about 0.5 weight percent to less than or equal to about 3 weight percent.

In one aspect, the electrically-conductive material is selected from the group consisting of: carbon black, acetylene black, graphene nanoplatelets, carbon nanotubes, graphite, or a combination thereof.

In one aspect, the electrically-conductive material includes the carbon nanotubes.

In one aspect, the polymer binder is present in the electrode in an amount greater than or equal to about 0.5 weight percent to less than or equal to about 0.3 weight percent.

In one aspect, the polymer binder is selected from the group consisting of polyvinylidene fluoride (PVDF), polytetrafluoroethylene (PTFE), poly(acrylic acid) (PAA), copolymers thereof, and admixtures thereof.

In one aspect, the nickel content of the first electroactive material is greater than or equal to about 75 mole percent.

In one aspect, the nickel content of the first electroactive material is greater than or equal to about 90 mole percent.

In one aspect, the electrode is configured to have an areal capacity of greater than or equal to about 3 mAh/cm². The electrode is configured to have a specific capacity of greater than or equal to about 180 mAh/g.

In various aspects, the present disclosure provides an electrochemical cell. The electrochemical cell includes a positive electrode, a negative electrode, a polymeric separator, and an electrolyte. The positive electrode includes a positive electroactive material and a polymeric binder. The positive electroactive material is present in an amount greater than 95 weight percent of the positive electrode. The positive electroactive material includes a first electroactive material, a second electroactive material, and a third electroactive material. The first electroactive material includes a lithium nickel manganese cobalt oxide (NMC), a lithium nickel manganese cobalt aluminum oxide (NMCA), a lithiated nickel cobalt aluminate (NCA), or a combination thereof. The first electroactive material has a nickel content of greater than or equal to about 60 mole percent. The second electroactive material includes a phosphate-containing positive electroactive material. The third electroactive material includes a lithium manganese oxide (LMO). The negative electrode includes a negative electroactive material. The polymeric separator is between the negative electrode and the positive electrode.

In one aspect, the electrolyte includes a solvent and a lithium salt. The solvent is selected from the group consisting of: ethylene carbonate (EC), ethylmethyl carbonate (EMC), diethyl carbonate (DEC), dimethyl carbonate (DMC), vinylene carbonate (VC), fluoroethylene carbonate FEC), and combinations thereof. The lithium salt is selected from the group consisting of: lithium hexafluorophosphate (LiPF₆), lithium tetrafluoroborate (LiBF₄), lithium bis(fluorosulfonyl)imide (LiFSI), lithium bis(trifluoromethanesulfonyl)imide LiTFSI, lithium bis(oxolato)borate (LiBOB), and combinations thereof.

In one aspect, the positive electrode defines a plurality of pores. A portion of the electrolyte is in at least a portion of the plurality of pores. A porosity of the positive electrode is greater than or equal to about 20 volume percent to less than or equal to about 40 volume percent. The electrochemical cell is configured to have a discharge capacity retention of greater than or equal to about 90%.

In various aspects, the present disclosure provides a method of manufacturing an electrode. The method includes preparing a slurry. The slurry includes a positive electroactive material, an electrically-conductive material, and a polymer binder solution. The positive electroactive material includes a first electroactive material, a second electroactive material, and a third electroactive material. The first electroactive material includes a lithium nickel manganese cobalt oxide (NMC), a lithium nickel manganese cobalt aluminum oxide (NMCA), a lithiated nickel cobalt aluminate (NCA), or a combination thereof. The first electroactive material has a nickel content of greater than or equal to about 60 mole percent. The second electroactive material includes a phosphate-containing positive electroactive material. The third electroactive material includes a lithium manganese oxide (LMO). The method further includes casting the slurry onto a substrate. The method further includes drying the slurry to form electrode.

In one aspect, the slurry has solids content of greater than or equal to about 65 weight percent.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of an exemplary electrochemical cell;

FIG. 2 is a schematic illustration of a positive electrode according to various aspects of the present disclosure;

FIG. 3 is a flowchart depicting a method of manufacturing the positive electrode of FIG. 2;

FIG. 4 is a graph depicting expected and actual exothermic energy as a function for positive electrodes including different weight percentages of NCMA according to various aspects of the present disclosure;

FIG. 5 is a graph depicting heat flow as a function of temperature for various positive electrode compositions according to various aspects of the present disclosure;

FIG. 6 is a graph depicting heat flow as a function of temperature for various positive electrodes, with and without electrolyte, according to various aspects of the present disclosure; and

FIG. 7 is a graph depicting capacity retention as function of cycle for electrochemical cells including various positive electroactive materials according to various aspects of the present disclosure.

In the drawings, reference numbers may be reused to identify similar and/or identical elements.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to rechargeable lithium-ion batteries, which may be used in vehicle applications. However, the present technology may also be used in other electrochemical devices that cycle lithium ions, such as handheld electronic devices or energy storage systems (ESS).

### General Electrochemical Cell Function, Structure, and Composition

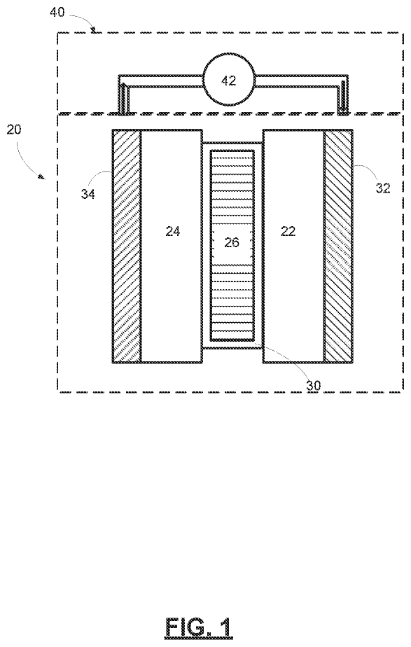

By way of background, an exemplary and schematic illustration of an electrochemical cell (also referred to as a battery) 20 is shown in FIG. 1. Although the illustrated examples include a single positive electrode or cathode and a single negative electrode or anode, the skilled artisan will recognize that the present disclosure also contemplates various other configurations, including those having one or more cathodes and one or more anodes, as well as various current collectors with electroactive layers disposed on or adjacent to one or more surfaces thereof.

A typical lithium-ion battery 20 includes a first electrode (such as a negative electrode 22 or anode) opposing a second electrode (such as a positive electrode 24 or cathode) and a separator 26 and/or electrolyte 30 disposed therebetween. While not shown, often in a lithium-ion battery pack, batteries or cells may be electrically connected in a stack or winding configuration to increase overall output. Lithium-ion batteries operate by reversibly passing lithium ions between the first and second electrodes. For example, lithium ions may move from the positive electrode 24 to the negative electrode 22 during charging of the battery, and in the opposite direction when discharging the battery. The electrolyte 30 is suitable for conducting lithium ions and may be in liquid, gel, or solid form.

When a liquid or semi-liquid/gel electrolyte is used, the separator 26 (e.g., a microporous polymeric separator) is thus disposed between the two electrodes 22, 24 and may comprise the electrolyte 30, which may also be present in the pores of the negative electrode 22 and positive electrode 24. When a solid electrolyte is used, the microporous polymeric separator 26 may be omitted. The solid-state electrolyte may also be mixed into the negative electrode 22 and the positive electrode 24. A negative electrode current collector 32 may be positioned at or near the negative electrode 22 and a positive electrode current collector 34 may be positioned at or near the positive electrode 24. An interruptible external circuit 40 and a load device 42 connects the negative electrode 22 (through its current collector 32) and the positive electrode 24 (through its current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte solution 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of transition metal ions, at the positive electrode 24 so that electrons and lithium ions are produced. The lithium ions flow from the negative electrode 22 through the electrolyte 30 across the separator 26 to replenish the positive electrode 24 with lithium for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, the separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. The negative electrode current collector 32 and positive electrode current collector 34 respectively collect and move free electrons to and from an external circuit 40.

Further, as noted above, when a liquid or semi-liquid electrolyte is used, the separator 26 operates as an electrical insulator by being sandwiched between the negative electrode 22 and the positive electrode 24 to prevent physical contact and thus, the occurrence of a short circuit. The separator 26 provides not only a physical and electrical barrier between the two electrodes 22, 24, but also contains the electrolyte solution in a network of open pores during the cycling of lithium ions, to facilitate functioning of the battery 20. The solid-state electrolyte layer may serve a similar ion conductive and electrically insulating function, but without needing a separator 26 component.

The battery 20 can include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the battery 20 may also be a solid-state battery that includes a solid-state electrolyte that may have a different design, as known to those of skill in the art.

Electrodes can generally be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating positive electrodes and negative electrodes with separators disposed therebetween. Batteries may be “monopolar,” such that all positive electrodes are in parallel and all negative electrodes are in parallel for each cell, and/or “bipolar” batteries, such that the negative current collector is flush with the positive electrode current collector (as with fuel cells). While the positive electroactive materials can be used in batteries for primary or single charge use, the resulting batteries generally have desirable cycling properties for secondary battery use over multiple cycling of the cells.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

The present technology pertains to making improved electrochemical cells, especially lithium-ion batteries. In various instances, such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of example.

### Electrolyte

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution that includes a lithium salt dissolved in an organic solvent or a mixture of organic solvents. Numerous non-aqueous liquid electrolyte 30 solutions may be employed in the lithium-ion battery 20. In certain variations, the electrolyte 30 may include an aqueous solvent (i.e., a water-based solvent) or a hybrid solvent (e.g., an organic solvent including at least 1% water by weight).

Appropriate lithium salts generally have inert anions. Examples of lithium salts that may be dissolved in an organic solvent to form the non-aqueous liquid electrolyte solution include lithium hexafluorophosphate (LiPF₆); lithium perchlorate (LiCIO₄), lithium tetrachloroaluminate (LiAICI₄), lithium iodide (Lil); lithium bromide (LiBr); lithium thiocyanate (LiSCN); lithium tetrafluoroborate (LiBF₄); lithium difluorooxalatoborate (LiBF₂(C₂O₄)) (LiODFB), lithium tetraphenylborate (LiB(C₆H₅)₄); lithium bis (oxalate)borate (LiB(C₂O₄)₂) (LiBOB); lithium tetrafluorooxalatophosphate (LiPF₄(C₂O₄)) (LiFOP), lithium nitrate (LiNO₃), lithium hexafluoroarsenate (LiAsF₆); lithium trifluoromethanesulfonate (LiCF₃SO₃); lithium bis(trifluoromethanesulfonimide) (LITFSI) (LiN(CF₃SO₂)₂); lithium fluorosulfonylimide (LiN(FsO₂)₂) (LIFSI); and combinations thereof. In certain variations, the electrolyte 30 may include a 1 M concentration of the lithium salts.

These lithium salts may be dissolved in a variety of organic solvents, such as organic ethers or organic carbonates, by way of example. Organic ethers may include dimethyl ether, glyme (glycol dimethyl ether or dimethoxyethane (DME, e.g., 1,2-dimethoxyethane)), diglyme (diethylene glycol dimethyl ether or bis(2-methoxyethyl) ether), triglyme (tri(ethylene glycol) dimethyl ether), additional chain structure ethers, such as 1-2-diethoxyethane, ethoxymethoxyethane, 1,3-dimethoxypropane (DMP), cyclic ethers, such as tetrahydrofuran, 2-methyltetrahydrofuran, and combinations thereof. In certain variations, the organic ether compound is selected from the group consisting of: tetrahydrofuran, 2-methyl tetrahydrofuran, dioxolane, dimethoxy ethane (DME), diglyme (diethylene glycol dimethyl ether), triglyme (tri(ethylene glycol) dimethyl ether), 1,3-dimethoxypropane (DMP), and combinations thereof. Carbonate-based solvents may include various alkyl carbonates, such as cyclic carbonates (e.g., ethylene carbonate (EC), propylene carbonate (PC), butylene carbonate) and acyclic carbonates (e.g., dimethyl carbonate (DMC), diethyl carbonate (DEC), ethyl methyl carbonate (EMC)). Ether-based solvents include cyclic ethers (e.g., tetrahydrofuran, 2-methyltetrahydrofuran, 1,3-dioxolane) and chain structure ethers (e.g., 1,2-dimethoxyethane, 1-2-diethoxyethane, ethoxymethoxyethane).

In various embodiments, appropriate solvents in addition to those described above may be selected from propylene carbonate, dimethyl carbonate, diethyl carbonate, methyl ethyl carbonate, γ-butyrolactone, dimethyl sulfoxide, acetonitrile, nitromethane and mixtures thereof.

Where the electrolyte is a solid-state electrolyte, it may include a compound selected from the group consisting of: LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS5Cl, Li₆PS₅Br, Li₆PS₅I, Li₃OCl, Li_{2.99}Ba_{0.005}ClO, or any combination thereof.

### Porous Separator

The porous separator 26 may include, in certain variations, a microporous polymeric separator including a polyolefin, including those made from a homopolymer (derived from a single monomer constituent) or a heteropolymer (derived from more than one monomer constituent), which may be either linear or branched. In certain aspects, the polyolefin may be polyethylene (PE), polypropylene (PP), or a blend of PE and PP, or multi-layered structured porous films of PE and/or PP. Commercially available polyolefin porous separator 26 membranes include CELGARD® 2500 (a monolayer polypropylene separator) and CELGARD® 2340 (a trilayer polypropylene/polyethylene/polypropylene separator) available from Celgard LLC.

When the porous separator 26 is a microporous polymeric separator, it may be a single layer or a multi-layer laminate. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also include other polymers alternatively or in addition to the polyolefin such as, but not limited to, polyethylene terephthalate (PET), polyvinylidene fluoride (PVDF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylene naphthenate, polybutene, polymethylpentene, polyolefin copolymers, acrylonitrile-butadiene styrene copolymers (ABS), polystyrene copolymers, polymethylmethacrylate (PMMA), polysiloxane polymers (e.g., polydimethylsiloxane (PDMS)), polybenzimidazole (PBI), polybenzoxazole (PBO), polyphenylenes, polyarylene ether ketones, polyperfluorocyclobutanes, polyvinylidene fluoride copolymers (e.g., PVDF—hexafluoropropylene or (PVDF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or a combination thereof.

Furthermore, the porous separator 26 may be mixed with a ceramic material or its surface may be coated in a ceramic material. For example, a ceramic coating may include alumina (Al₂O₃), silicon dioxide (SiO₂), or combinations thereof. Various commercially available polymers and commercial products for forming the separator 26 are contemplated, as well as the many manufacturing methods that may be employed to produce such a microporous polymer separator 26.

### Solid-State Electrolyte

In various aspects, the porous separator 26 and the electrolyte 30 may be replaced with a solid state electrolyte (SSE) that functions as both an electrolyte and a separator. The SSE may be disposed between a positive electrode and a negative electrode. The SSE facilitates transfer of lithium ions, while mechanically separating and providing electrical insulation between the negative and positive electrodes 22, 24. By way of example, SSEs may include LiTi₂(PO₄)₃, LiGe₂(PO₄)₃, Li₇La₃Zr₂O₁₂, Li₃XLa_{2/3}-XTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, polyethylene oxide (PEO) based polymers, polycarbonates, polyesters, polynitriles (e.g., polyacrylonitrile (PAN)), polyalcohols (e.g., polyvinyl alcohol (PVA)), polyamines (e.g., polyethyleneimine (PEI)), polysiloxane (e.g., polydimethylsiloxane (PDMS)) and fluoropolymers (e.g., polyvinylidene fluoride (PVDF), polyvinylidene fluoride-hexafluoropropylene (PVDF-HFP)), bio-polymers like lignin, chitosan and cellulose, and any combinations thereof.

### Current Collectors

The negative and positive electrodes 22, 24 are generally associated with the respective negative and positive electrode current collectors 32, 34 to facilitate the flow of electrons between the electrode and the external circuit 40. The current collectors 32, 34 are electrically conductive and can include metal, such as a metal foil, a metal grid or screen, or expanded metal. Expanded metal current collectors refer to metal grids with a greater thickness such that a greater amount of electroactive material is placed within the metal grid. By way of example, electrically-conductive materials include copper, nickel, aluminum, stainless steel, titanium, alloys thereof, or combinations thereof.

The positive electrode current collector 34 may be formed from aluminum or any other appropriate electrically conductive material known to those of skill in the art. The negative electrode current collector 32 may be formed from copper or any other appropriate electrically conductive material known to those of skill in the art. Negative electrode current collectors do not typically include aluminum because aluminum reacts with lithium, thereby causing large volume expansion and contraction. The drastic volume changes may lead to fracture and/or pulverization of the current collector.

### Positive & Negative Electrodes

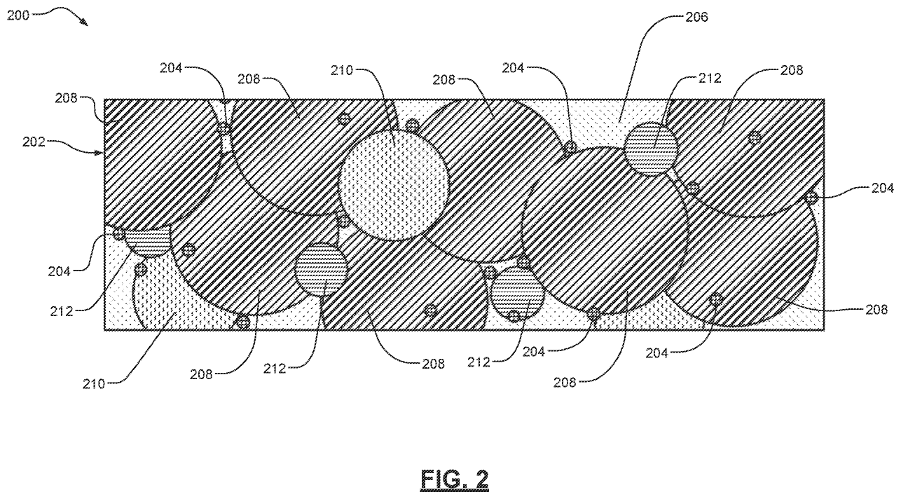

The positive electrode 24 may be formed from or include a lithium-based active material that can undergo lithium intercalation and deintercalation, alloying and dealloying, or plating and stripping, while functioning as the positive terminal of the lithium-ion battery 20. The positive electrode 24 may include a positive electroactive material. Positive electroactive materials may include one or more transition metal cations, such as manganese (Mn), nickel (Ni), cobalt (Co), chromium (Cr), iron (Fe), vanadium (V), and combinations thereof. However, in certain variations, the positive electrode 24 is substantially free of select metal cations, such as nickel (Ni) and cobalt (Co). Positive electrode materials (also referred to as “positive electroactive materials”) are described in greater detail below in the discussion accompanying FIG. 2.

The negative electrode 22 may include a negative electroactive material as a lithium host material capable of functioning as a negative terminal of the lithium-ion battery 20. Common negative electroactive materials include lithium insertion materials or alloy host materials. Negative electrode materials (also referred to as “negative electroactive materials”). In certain aspects, the negative electrode 22 includes metallic lithium and the negative electrode 22 is a lithium metal electrode (LME). The lithium-ion battery 20 may be a lithium-metal battery or cell. Metallic lithium for use in the negative electrode of a rechargeable battery has various potential advantages, including having the highest theoretical capacity and lowest electrochemical potential. Thus, batteries incorporating lithium-metal anodes can have a higher energy density that can potentially double storage capacity, so that the battery may be half the size, but still last the same amount of time as other lithium-ion batteries.

### High Thermal Stability, High Performance Electrochemical Cells

Nickel-containing electroactive materials may provide desirable performance characteristics. More specifically, as nickel content increases in materials such as lithium nickel manganese cobalt oxide (NMC), lithium nickel manganese cobalt aluminum oxide (NMCA), and/or lithiated nickel cobalt aluminate (NCA), energy density and capacity retention also increase. However, as nickel content increases, thermal stability decreases. Thermal stability of the positive electrode affects timing and severity of thermal runaway in the case of a thermal event. Accordingly, it would be desirable to provide a positive electrode material having high thermal stability, high energy density, and high capacity retention.

In various aspects, the present disclosure provides, a positive electroactive material that includes a synergistic combination of materials to provide high thermal stability, high energy density, and high capacity retention. The positive electroactive material includes (i) a nickel-containing layered metal oxide material, such as NMC, NCMA, and/or NCA; (ii) a phosphate-containing positive electroactive material (e.g., a polyanion material, such as a lithium iron phosphate (LFP), a lithium manganese iron phosphate (LMFP), lithium vanadium phosphate (LVP), a transition metal doped lithium vanadium phosphate (LVMP), and/or lithium vanadium fluorophosphate (LVPF)); and (iii) a spinel material, such as a lithium manganese oxide (LMO). In certain aspects, the positive electrode includes greater than or equal to about 95 weight percent of the positive electroactive material. In certain aspects, the NMC and/or NCMA has greater than or equal to about 60 mole percent nickel. This combination of positive electroactive materials performs better than expected based on the rule of mixtures in terms of thermal stability (see discussion accompanying FIG. 4). Compared to an electrode including only a nickel-containing active material (e.g., NMCA), the present synergistic electroactive material is configured to generate less heat during a thermal event and provide a longer duration of thermal stability prior to the occurrence of a thermal event. Additionally, the present electroactive material provides only a minor decrease in capacity and a better capacity retention (i.e., slower and/or smaller capacity fade) than the component pure electroactive material (see, e.g., FIG. 7 and accompanying discussion).

With reference to FIG. 2, a positive electrode 200 according to various aspects of the present disclosure is provided. The positive electrode 200 includes a positive electroactive material 202, an electrically-conductive material 204 (also referred to as a “conductive additive”), and a polymer binder 206. The positive electroactive material 202 includes a first electroactive material 208, a second electroactive material 210, and a third electroactive material 212. The first, second, and third electroactive materials 208, 210, 212 are all different electroactive materials that synergistically provide a high energy density, high capacity retention, and high thermal stability (e.g., in terms of peak heat flow, total heat release, and onset of thermal event), as will be described in greater detail below.

The first electroactive material 208 is a nickel-containing material. The first electroactive material 208 may be a layered oxide. The first electroactive material may include NMC, NMCA, NCA, or a combination thereof. NMC has the chemical formula LiNiₓMn_{y}Co_{z}O₂, where x+y+z=1. By way of example, the NMC may include NMC 523, NMC 622, NMC 721, NMC 811, or a combination thereof. NMCA has the chemical formula LiNi_{w}MnₓCo_{y}Al_{z}O₂, where w+x+y+z=1. By way of example, the NMCA may include LiNi_{0.89}Mn_{0.05}Co_{0.05}Al_{0.01}O₂ or LiNi_{0.79}Mn_{0.1}Co_{0.1}Al_{0.01}O₂. The first electroactive material 208 may include nickel in an amount greater than or equal to about 50 mole percent, optionally greater than or equal to about 55 mole percent, optionally greater than or equal to about 60 mole percent, optionally greater than or equal to about 65 mole percent, optionally greater than or equal to about 70 mole percent, optionally greater than or equal to about 75 mole percent, optionally greater than or equal to about 80 mole percent, optionally greater than or equal to about 85 mole percent, optionally greater than or equal to about 90 mole percent, or optionally greater than or equal to about 95 mole percent. The first electroactive material 208 may include nickel in an amount less than 100 mole percent, optionally less than or equal to about 95 mole percent, optionally less than or equal to about 90 mole percent, optionally less than or equal to about 85 mole percent, optionally less than or equal to about 80 mole percent, optionally less than or equal to about 75 mole percent, optionally less than or equal to about 70 mole percent, or optionally less than or equal to about 65 mole percent.

The positive electroactive material 202 may include the first electroactive material 208 in an amount greater than or equal to about 30 weight percent, optionally greater than or equal to about 33 weight percent, optionally greater than or equal to about 35 weight percent, optionally greater than or equal to about 40 weight percent, optionally greater than or equal to about 45 weight percent, optionally greater than or equal to about 50 weight percent, optionally greater than or equal to about 55 weight percent, optionally greater than or equal to about 60 weight percent, optionally greater than or equal to about 65 weight percent, optionally greater than or equal to about 70 weight percent, optionally greater than or equal to about 75 weight percent, optionally greater than or equal to about 80 weight percent, optionally greater than or equal to about 85 weight percent, or optionally greater than or equal to about 90 weight percent. The positive electroactive material 202 may include the first electroactive material 208 in an amount less than or equal to about 94 weight percent, optionally less than or equal to about 90 weight percent, optionally less than or equal to about 85 weight percent, optionally less than or equal to about 80 weight percent, optionally less than or equal to about 75 weight percent, optionally less than or equal to about 70 weight percent, optionally less than or equal to about 65 weight percent, optionally less than or equal to about 60 weight percent, optionally less than or equal to about 55 weight percent, optionally less than or equal to about 50 weight percent, optionally less than or equal to about 45 weight percent, optionally less than or equal to about 40 weight percent, or optionally less than or equal to about 35 weight percent. In an example, the positive electroactive material 202 includes the first electroactive material 208 in an amount greater than or equal to about 65 weight percent to less than or equal to about 85 weight percent, or optionally greater than or equal to about 70 weight percent to less than or equal to about 80 weight percent.

In certain aspects, the second electroactive material 210 includes a phosphate-containing positive electroactive material. The phosphate may be bonded to a metal core. In certain aspects, the second electroactive material 210 may include a phosphate polyanion. By way of example, the second electroactive material 210 may include LFP, an LMFP, LVP, an LVMP, LVPF, or a combination thereof. LFP has the chemical formula LiFePO₄. LMFP has the chemical formula LiMnₓFe₁₋ₓPO₄, where 0≤x≤1. Examples of LiMnₓFe₁₋ₓPO₄, where 0≤x≤1, include LiMn_{0.7}Fe_{0.3}PO₄, LiMn_{0.6}Fe_{0.4}PO₄, LiMn_{0.8}Fe_{0.2}PO₄, and LiMn_{0.75}Fe_{0.25}PO₄. LVP has the chemical formula Li₃V₂(PO₄)₃. LVMP has the chemical formula Li₃V₂₋ₓMₓ(PO₄)₃) where 0≤x≤2 and M is a transition metal such as Fe, Al, Zn, Mn, Mg, Co, and/or Cr. Example values of x include 0.05, 0.1, 0.25, and 0.5. In an example, M is iron such that the LVMP is lithium vanadium iron phosphate (LVFP) having the chemical formula Li₃V₂₋ₓFeₓ(PO₄)₃, where 0≤x≤2. Examples LVFP include Li₃V_{1.95}Fe_{0.05}(PO₄)₃, Li₃V_{1.9}Fe_{0.1}(PO₄)₃, Li₃V_{1.75}Fe_{0.25}(PO₄)₃, and Li₃V_{1.5}Fe_{0.5}(PO₄)₃. LVPF has the chemical formula LiVPO₄F. In certain aspects, the second electrode material may include different or additional lithiated positive electroactive materials that include phosphate bonds to metal centers.

The positive electroactive material 202 may include the second electroactive material 210 in an amount greater than or equal to about 2 weight percent, optionally greater than or equal to about 5 weight percent, optionally greater than or equal to about 10 weight percent, optionally greater than or equal to about 15 weight percent, optionally greater than or equal to about 20 weight percent, optionally greater than or equal to about 25 weight percent, or optionally greater than or equal to about 30 weight percent. The positive electroactive material 202 may include the second electroactive material 210 in an amount less than or equal to about 33 weight percent, optionally less than or equal to about 30 weight percent, optionally less than or equal to about 25 weight percent, optionally less than or equal to about 20 weight percent, optionally less than or equal to about 15 weight percent, optionally less than or equal to about 10 weight percent, or optionally less than or equal to about 5 weight percent. In an example, the positive electroactive material 202 includes the second electroactive material 210 in an amount greater than or equal to about 5 weight percent to less than or equal to about 20 weight percent, or optionally greater than or equal to about 10 weight percent to less than or equal to about 15 weight percent.

The third electroactive material 212 includes an LMO. The LMO may have the formula Li₍₁₊ₓ₎Mn₍₂₋ₓ₎O₄), where x is typically <0.15. In one example, the LMO includes LiMn₂O₄.

The positive electroactive material 202 may include the third electroactive material 212 in an amount greater than or equal to about 2 weight percent, optionally greater than or equal to about 5 weight percent, optionally greater than or equal to about 10 weight percent, optionally greater than or equal to about 15 weight percent, optionally greater than or equal to about 20 weight percent, optionally greater than or equal to about 25 weight percent, or optionally greater than or equal to about 30 weight percent. The positive electroactive material 202 may include the third electroactive material 212 in an amount less than or equal to about 33 weight percent, optionally less than or equal to about 30 weight percent, optionally less than or equal to about 25 weight percent, optionally less than or equal to about 20 weight percent, optionally less than or equal to about 15 weight percent, optionally less than or equal to about 10 weight percent, or optionally less than or equal to about 5 weight percent. In an example, the positive electroactive material 202 includes the third electroactive material 212 in an amount greater than or equal to about 5 weight percent to less than or equal to about 20 weight percent, or optionally greater than or equal to about 10 weight percent to less than or equal to about 15 weight percent.

The positive electrode 200 includes the positive electroactive material 202 in an amount greater than or equal to about 50 weight percent, optionally greater than or equal to about 55 weight percent, optionally greater than or equal to about 60 weight percent, optionally greater than or equal to about 65 weight percent, optionally greater than or equal to about 70 weight percent, optionally greater than or equal to about 75 weight percent, optionally greater than or equal to about 80 weight percent, optionally greater than or equal to about 85 weight percent, optionally greater than or equal to about 90 weight percent, optionally greater than or equal to about 95 weight percent, or optionally greater than or equal to about 96 weight percent, optionally greater than or equal to about 97 weight percent. The positive electrode 200 includes the positive electroactive material 202 in an amount less than or equal to about 98 weight percent, optionally less than or equal to about 97 weight percent, optionally less than or equal to about 96 weight percent, optionally less than or equal to about 95 weight percent, optionally less than or equal to about 90 weight percent, optionally less than or equal to about 85 weight percent, optionally less than or equal to about 80 weight percent, optionally less than or equal to about 75 weight percent, optionally less than or equal to about 70 weight percent, optionally less than or equal to about 65 weight percent, optionally less than or equal to about 60 weight percent, or optionally less than or equal to about 55 weight percent. In an example, the positive electrode 200 includes the positive electroactive material in an amount greater than or equal to about 95 weight percent to less than or equal to about 98 weight percent.

In certain aspects, the polymer binder 206 may include polyvinylidene fluoride (PVDF), polytetrafluoroethylene (PTFE), poly(acrylic acid) (PAA), copolymers thereof, and admixtures thereof. Copolymers of PVDF may include PVDF-polytetrafluoroethylene (PVDF-PTFE), PVDF-hexafluoropropylene (PVDF-HFP), or combinations thereof, by way of example.

The positive electrode 200 includes the polymer binder 206 in an amount greater than or equal to about 1 weight percent, optionally greater than or equal to about 2 weight percent, optionally greater than or equal to about 3 weight percent, optionally greater than or equal to about 4 weight percent, optionally greater than or equal to about 5 weight percent, optionally greater than or equal to about 10 weight percent, optionally greater than or equal to about 15 weight percent, optionally greater than or equal to about 20 weight percent, or optionally greater than or equal to about 25 weight percent. The positive electrode 200 includes the polymer binder 206 in an amount less than or equal to about 30 weight percent, optionally less than or equal to about 25 weight percent, optionally less than or equal to about 20 weight percent, optionally less than or equal to about 15 weight percent, optionally less than or equal to about 10 weight percent, optionally less than or equal to about 5 weight percent, optionally less than or equal to about 4 weight percent, optionally less than or equal to about 3 weight percent, or optionally less than or equal to about 2 weight percent. In an example, the positive electrode 200 includes the polymer binder 206 in an amount greater than or equal to about 1 weight percent to less than or equal to about 5 weight percent.

In certain aspects, the electrically-conductive material 204 may include a conductive carbon. The conductive carbon may include carbon black, acetylene black, graphene nanoplatelets, carbon nanotubes, graphite, or any combination thereof, by way of example. In an example, the electrically-conductive material includes carbon nanotubes.

The positive electrode 200 may include the electrically-conductive material 204 in an amount greater than or equal to about 0.5 weight percent, greater than or equal to about 1 weight percent, optionally greater than or equal to about 2 weight percent, optionally greater than or equal to about 3 weight percent, optionally greater than or equal to about 4 weight percent, optionally greater than or equal to about 5 weight percent, optionally greater than or equal to about 10 weight percent, optionally greater than or equal to about 15 weight percent, optionally greater than or equal to about 20 weight percent, optionally greater than or equal to about 25 weight percent, optionally greater than or equal to about 30 weight percent, optionally greater than or equal to about 35 weight percent, optionally greater than or equal to about 40 weight percent, or optionally greater than or equal to about 45 weight percent. The positive electrode 200 may include the electrically-conductive material 204 in an amount less than or equal to about 50 weight percent, optionally less than or equal to about 45 weight percent, optionally less than or equal to about 40 weight percent, optionally less than or equal to about 35 weight percent, optionally less than or equal to about 30 weight percent, optionally less than or equal to about 25 weight percent, optionally less than or equal to about 20 weight percent, optionally less than or equal to about 15 weight percent, optionally less than or equal to about 10 weight percent, optionally less than or equal to about 5 weight percent, optionally less than or equal to about 4 weight percent, optionally less than or equal to about 3 weight percent, or optionally less than or equal to about 2 weight percent. In an example, the positive electrode 200 includes the electrically-conductive material in an amount greater than or equal to about 0.5 weight percent to less than or equal to about 4 weight percent.

Accordingly, the positive electrode 200 may define a plurality of pores (not shown). In certain aspects, a porosity of the positive electrode 200 may be greater than or equal to about 15 volume percent, optionally greater than or equal to about 20 volume percent, optionally greater than or equal to about 25 volume percent, optionally greater than or equal to about 30 volume percent, optionally greater than or equal to about 35 volume percent, or optionally greater than or equal to about 40 volume percent. The porosity may be less than or equal to about 45 volume percent, optionally less than or equal to about 40 volume percent, optionally less than or equal to about 35 volume percent, optionally less than or equal to about 30 volume percent, optionally less than or equal to about 25 volume percent, or optionally less than or equal to about 20 volume percent. In an example, the porosity may be greater than or equal to about 20 weight percent to less than or equal to about 40 weight percent, optionally greater than or equal to about 25 weight percent to less than or equal to about 35 weight percent, or optionally about 30 weight percent. In certain aspects, as will be described in greater detail below, the pores may be partially or entirely filled with electrolyte.

In certain aspects, the positive electrode (in a dry state without electrolyte in pores) may have an exothermic energy measured by differential scanning calorimetry (DSC) that is less than an electrode where the positive electroactive material consists of the first electroactive material (e.g., NMCA) alone. In certain aspects, when charged to 4.3 V vs. lithium, the positive electrode 200 may have an exothermic energy of less than or equal to about 100 J/g, optionally less than or equal to about 95 J/g, optionally less than or equal to about 90 J/g, optionally less than or equal to about 85 J/g, optionally less than or equal to about 80 J/g, optionally less than or equal to about 75 J/g, optionally less than or equal to about 70 J/g, optionally less than or equal to about 65 J/g, or optionally less than or equal to about 60 J/g.

In certain aspects, the positive electrode 200 is configured to have a specific capacity of greater than or equal to about 150 mAh/g, optionally greater than or equal to about 155 mAh/g, optionally greater than or equal to about 160 mAh/g, optionally greater than or equal to about 165 mAh/g, optionally greater than or equal to about 170 mAh/g, optionally greater than or equal to about 175 mAh/g, optionally greater than or equal to about 180 mAh/g, optionally greater than or equal to about 185 mAh/g, optionally greater than or equal to about 190 mAh/g, or optionally greater than or equal to about 195 mAh/g.

In certain aspects, the positive electrode 200 is configured to have an areal capacity of greater than or equal to about 3 mAh/cm², optionally greater than or equal to about 4 mAh/cm², optionally greater than or equal to about 5 mAh/cm², optionally greater than or equal to about 6 mAh/cm², optionally greater than or equal to about 7 mAh/cm², optionally greater than or equal to about 8 mAh/cm², or optionally greater than or equal to about 9 mAh/cm². The areal capacity may be less than or equal to about 10 mAh/cm², optionally less than or equal to about 9 mAh/cm², optionally less than or equal to about 8 mAh/cm², optionally less than or equal to about 7 mAh/cm², optionally less than or equal to about 6 mAh/cm², optionally less than or equal to about 5 mAh/cm², or optionally less than or equal to about 4 mAh/cm².

In various aspects, the present disclosure provides an electrochemical cell, such as a battery, including the positive electrode 200. Except for the positive electrode 200, the electrochemical cell may be similar to the electrochemical cell 20 of FIG. 1. The electrochemical cell further includes a negative electrode, positive and negative electrode current collectors, a separator, and an electrolyte.

The negative electrode includes a negative electrode active material. In certain aspects, the negative electroactive material may include a carbon material (e.g., graphite), silicon, silicon oxide, or combinations thereof. In other aspects, the negative electroactive material may include lithium metal.

The electrolyte may include a solvent and a lithium salt. In certain aspects, the solvent may include EC, EMC, DEC, DMC, fluoroethylene carbonate (FEC), vinylene carbonate (VC), or combinations thereof. The lithium salt may include LiPF₆, LiBF₄, LiTFSI, LiFSI, LiBOB, or combinations thereof. In certain aspect, a portion of the electrolyte may be in at least a portion of the pores of the positive electrode 200.

The electrochemical cell may have a higher discharge capacity retention than an electrochemical cell including a positive electroactive material consisting of the first electroactive material 208 only, the second electroactive 210 material only, or the third electroactive material 212 only. In certain aspects, after about 300 cycles the discharge capacity retention is greater than or equal to about 85 percent, optionally greater than or equal to about 90 percent, optionally greater than or equal to about 91 percent, optionally greater than or equal to about 92 percent, optionally greater than or equal to about 93 percent, optionally greater than or equal to about 94 percent, optionally greater than or equal to about 95 percent, or optionally greater than or equal to about 96 percent.

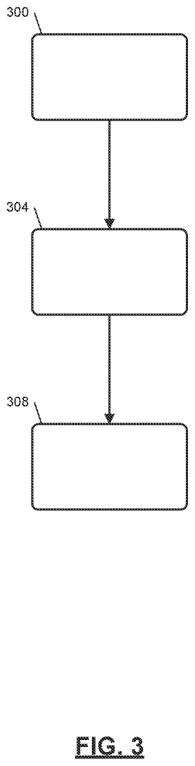

In various aspects, the present disclosure provides a method of manufacturing a positive electrode. Referring to FIG. 3, the method generally includes preparing a slurry at 300, casting the slurry onto a substrate at 304, and drying the slurry at 308 to form the electrode. The method is discussed in the context of the positive electrode 200 of FIG. 2; however, it is equally applicable to other electrodes according to various aspects of the present disclosure.

Preparing the slurry at 300 includes admixing the electroactive material 202, the electrically-conductive material 204, and a solution including a precursor to the polymer binder 206. In certain aspects, a solids content (i.e., the electroactive material 202 and the electrically-conductive material 204) of the slurry may be greater than or equal to about 65 weight percent to less than or equal to about 85 weight percent. At 304, casting the slurry onto the substrate may include casting the slurry only a current collector. At 308, drying the slurry includes removing at least a portion of a solvent from the solution of the polymer binder precursor. In various other aspects, other methods, such as extrusion, may be used to prepare the electrodes of the present disclosure.

### Example 1—Positive Electrodes

Three positive electroactive material (EAM) samples are prepared according to various aspects of the present disclosure, as shown in Table 1, below. Each of three EAM samples includes 97 weight percent positive EAM (see Table 1), 1.5 of the same polymer binder, and 1.5 weight percent of the same conductive carbon.

TABLE 1

| | NCMA | LMFP | LMO |
|---|---|---|---|
| | wt. % | wt. % | wt. % |
| | in EAM | in EAM | in EAM |
| First positive EAM Sample | 100 | 0 | 0 |
| Second positive EAM Sample | 80 | 10 | 10 |
| Third positive EAM Sample | 70 | 15 | 15 |

The NCMA is LiNi_{0.9}Co_{0.05}Mn_{0.03}Al_{0.02}O₂. The LMFP is LiMn_{0.7}Fe_{0.3}PO₄.

DSC is performed to determine heat flow and total heat release (which is assumed to the same as total exothermic energy released) for each of the three EAM samples. With reference to FIG. 4, a first x-axis 400 represents NCMA weight percent in the positive electroactive material. A second y-axis 402 represents specific capacity in mAh/g. A y-axis 404 represents exothermic energy in J/g. A line 406 represents expected exothermic energy as a function of NCMA content based on the rule of mixtures.

A first data point 408 represents actual exothermic energy for the first EAM sample. The first EAM sample has a specific capacity of 212 mAh/g and an exothermic energy of 127 J/g. Since the positive electroactive material includes NCMA alone, no synergistic effect on exothermic energy is observed and the result aligns with the expected value.

A second data point 410 represents actual exothermic energy for the second EAM sample. The second EAM sample has a specific capacity of 194 mAh/g (8% lower than that of the first EAM sample) and an exothermic energy of 75 J/g (40% lower than that of the first EAM sample). The second EAM sample performs better than would be expected according to the rule of mixtures in terms of exothermic energy (and accordingly, thermal stability) due to the synergistic effect of the three positive electroactive materials.

A third data point 412 represents actual exothermic energy for the third EAM sample. The third EAM sample has a specific capacity of 186 mAh/g (12% less than that of the first EAM sample) and an exothermic energy of 67 J/g (47% lower than that of the first EAM sample). The third EAM sample also performs better than would be expected according to the rule of mixtures in terms of exothermic energy (and accordingly, thermal stability) due to the synergistic effect of the three positive electroactive materials.

For each of the blended EAMs (second and third EAM samples), the thermal stability gain (% above that of the first EAM sample) has a greater magnitude than a magnitude of the capacity loss (% below that of the first EAM sample). As can be observed by comparing relative distances from the line 406 to the second and third data points 410, 412, respectively, the synergistic effect is greater as NMCA (and therefore, nickel) content increases.

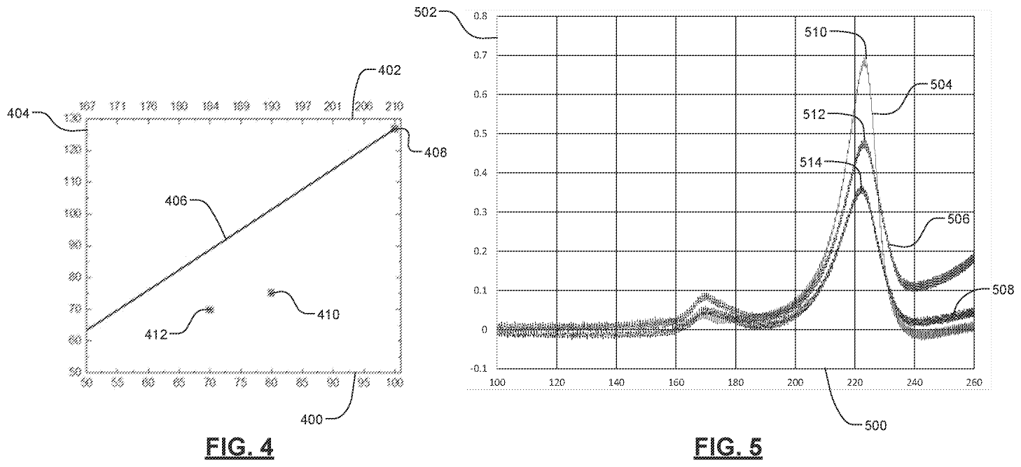

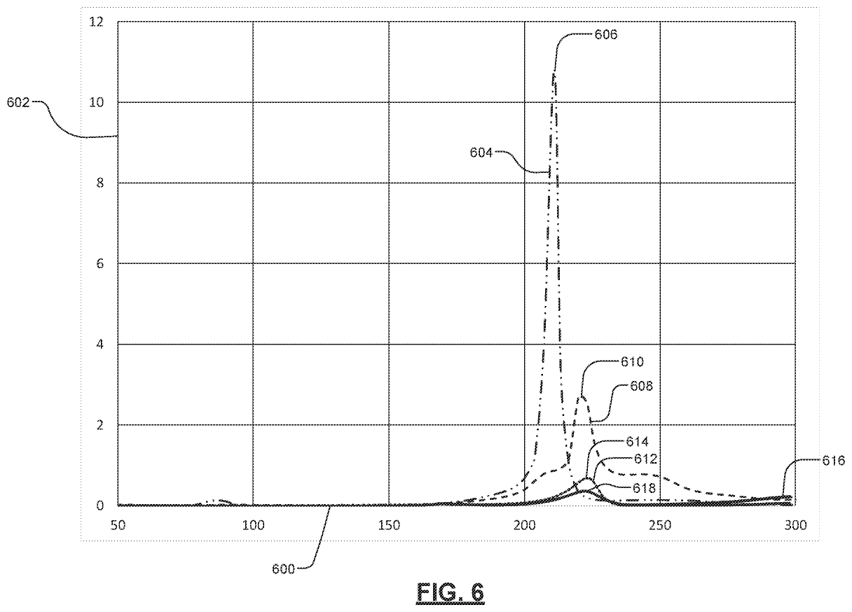

Referring to FIG. 5, an x-axis 500 represents temperature in ° C. and a y-axis 502 represents heat flow in mW/mg. A first curve 504 corresponds to the first EAM sample. A second curve 506 corresponds to the second EAM sample. A third curve 508 corresponds to the third EAM sample. The positive electrodes are de-lithiated by charging to 4.3V vs. Li in a coin cell. The samples are recovered, cleaned, and dried. The thermal behavior is observed by measuring the heat flow as a function of temperature during a temperature ramp using DSC.

The first, second, and third curves 504, 506, 508 have first, second, and third peaks 510, 512, 514, respectively. As shown by a difference between the first, second, and third peaks 510, 512, 514, heat flow decreases in the blended electroactive materials (second and third electrodes) compared to the NCMA electroactive material (first electrode). In general, as nickel content decreases, heat flow also decreases.

### Example 2—Positive Electrodes and Electrolyte

Four electrodes are prepared according to various aspects of the present disclosure, as shown in Table 2, below. Each of the electrodes includes 97 weight percent active material (Table 2), 1.5 weight percent of the same polymer binder, and 1.5 weight percent of the same conductive carbon. The electrolyte includes 1M LiPF₆ in EC:EMC 3:7+2 weight percent VC.

TABLE 2

| | Positive electroactive material | | | |
|---|---|---|---|---|
| | NCMA | LMFP | LMO | |
| | wt. % | wt. % | wt. % | Electrolyte |
| | in EAM | in EAM | in EAM | wt. % |
| First electrode | 100 | 0 | 0 | 30 |
| Second electrode | 70 | 15 | 15 | 30 |
| Third electrode | 100 | 0 | 0 | 0 |
| Fourth electrode | 70 | 15 | 15 | 0 |

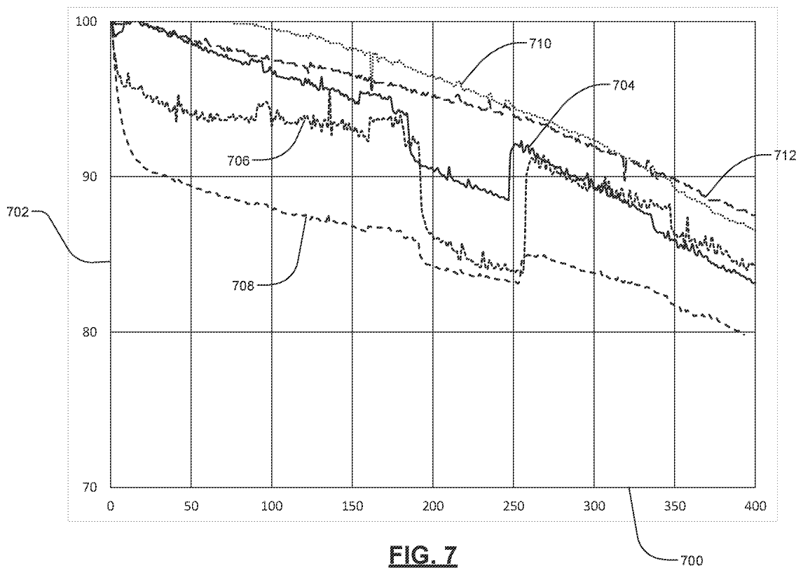

Referring to FIG. 6, an x-axis 600 represents temperature in ° C. and a y-axis 602 represents heat flow in mW/mg. A first curve 604 having a first peak 606 corresponds to the first electrode. A second curve 608 having a second peak 610 corresponds to the second electrode. A third curve 612 having a third peak 614 corresponds to the third electrode. A fourth curve 616 having a fourth peak 618 corresponds to the fourth electrode. The data is obtained in the same manner for FIG. 5, described above.

As demonstrated by comparing a magnitude of the first and third curves 604, 612 and the second and fourth curves 608, 616, presence of the electrolyte in the first and second electrodes amplifies the heat flow, thereby decreasing the thermal stability. More specifically, the first peak 606 is 10.83 mW/mg, while the second peak 610 is only 2.69 mW/mg, which is about 75% less than the first peak. Moreover, a total heat released (area under the curve normalized by heating rate) for the first electrode is 1109 J/g, while a total heat released for the second electrode is 643 J/g, which is about 42% less than that of the first electrode.

As shown by the horizontal shift between the second and first curves 608, 604, for the electrolyte-containing electrodes, the second peak 610 is horizontally shifted compared to the first peak 606. More specifically, the first peak 606 occurs at 211° C., while the second peak 610 occurs at 221° C. This indicates that the blended electrode material of the second electrode delays the onset of a thermal event such that the thermal event occurs at a higher temperatures. Accordingly, when electrolyte is present, the blended electroactive material of the present disclosure is configured to increase a temperature of thermal event onset compared to a single nickel-containing electroactive material.

### Example 3—Electrochemical Cells

Five electrochemical cells are prepared according to various aspects of the present disclosure, as shown in Table 3, below. Except for having different positive electrodes, the electrochemical cells are the same. Each of the positive electrodes includes 97 weight percent active material (Table 3), 1.5 weight percent of the same polymer binder, and 1.5 weight percent of the same conductive carbon. Each of the positive electrodes has a loading of 5 mAh/cm². Each of the electrochemical cells includes a graphite negative electrode, a 1M LiPF₆ in EC:EMC (3:7 wt/wt)+2 weight percent VC electrolyte, and a CELGARD 2325 separator.

TABLE 3

| | NCMA | LMFP | LMO |
|---|---|---|---|
| | wt. % in EAM | wt. % in EAM | wt. % in EAM |
| First positive electrode | 100 | 0 | 0 |
| Second positive electrode | 0 | 100 | 0 |
| Third positive electrode | 0 | 0 | 100 |
| Fourth positive electrode | 80 | 10 | 10 |
| Fifth positive electrode | 70 | 15 | 15 |

The cells are cycled at C/3 for at least 300 cycles. With reference to FIG. 7, an x-axis 700 represents cycle number and a y-axis 702 represents discharge capacity retention in %. A first curve 704 corresponds to the first electrode. %. A second curve 706 corresponds to the second electrode. A third curve 708 corresponds to the third electrode. A fourth curve 710 corresponds to the fourth electrode. A fifth curve 712 corresponds to the fifth electrode.

As shown by comparing the fourth and fifth curves 710, 712 to the first, second, and third curves 704, 706, 708, discharge capacity retention is improved in the cells including the blended positive electroactive materials. Additionally, over at least a portion of the cycle life, discharge capacity for the fourth electrochemical cell having the higher NCMA (and therefore, nickel) content is improved compared to the fifth electrochemical cell. Accordingly, nickel content (i.e., amount of the first electroactive material 208 of the electrode 200 of FIG. 2) may be increased to achieve higher discharge capacity retention.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed:

1. An electrode for an electrochemical cell, the electrode comprising:
a positive electroactive material in an amount greater than 95 weight percent of the electrode, the positive electroactive material including,
a first electroactive material including a lithium nickel manganese cobalt oxide (NMC), a lithium nickel manganese cobalt aluminum oxide (NMCA), a lithiated nickel cobalt aluminate (NCA), or a combination thereof, the first electroactive material having a nickel content of greater than or equal to about 60 mole percent,
a second electroactive material including a phosphate-containing positive electroactive material, and
a third electroactive material including a lithium manganese oxide (LMO); and
a polymeric binder.

2. The electrode of claim 1, wherein the phosphate-containing positive electroactive material includes lithium iron phosphate (LFP), a lithium manganese iron phosphate (LMFP), lithium vanadium phosphate (LVP), a transition metal doped lithium vanadium phosphate (LVMP), lithium vanadium fluorophosphate (LVPF), or a combination thereof.

3. The electrode of claim 1, wherein the first electroactive material is present in the positive electroactive material in an amount greater than or equal to about 33 weight percent to less than or equal to about 94 weight percent.

4. The electrode of claim 1, wherein the second electroactive material is present in the positive electroactive material in an amount greater than or equal to about 2 weight percent to less than or equal to about 33 weight percent.

5. The electrode of claim 1, wherein the third electroactive material is present in the positive electroactive material in an amount greater than or equal to about 2 weight percent to less than or equal to about 33 weight percent.

6. The electrode of claim 1, further comprising:
an electrically-conductive material.

7. The electrode of claim 6, wherein the electrically-conductive material is present in the electrode in an amount greater than or equal to about 0.5 weight percent to less than or equal to about 3 weight percent.

8. The electrode of claim 6, wherein the electrically-conductive material is selected from the group consisting of: carbon black, acetylene black, graphene nanoplatelets, carbon nanotubes, graphite, or a combination thereof.

9. The electrode of claim 8, wherein the electrically-conductive material includes the carbon nanotubes.

10. The electrode of claim 1, wherein the polymer binder is present in the electrode in an amount greater than or equal to about 0.5 weight percent to less than or equal to about 0.3 weight percent.

11. The electrode of claim 1, wherein the polymer binder is selected from the group consisting of polyvinylidene fluoride (PVDF), polytetrafluoroethylene (PTFE), poly(acrylic acid) (PAA), copolymers thereof, and admixtures thereof.

12. The electrode of claim 1, wherein the nickel content of the first electroactive material is greater than or equal to about 75 mole percent.

13. The electrode of claim 1, wherein the nickel content of the first electroactive material is greater than or equal to about 90 mole percent.

14. The electrode of claim 1, wherein the electrode is configured to have
an areal capacity of greater than or equal to about 3 mAh/cm², and
a specific capacity of greater than or equal to about 180 mAh/g.

15. An electrochemical cell comprising:
a positive electrode including,
a positive electroactive material in an amount greater than 95 weight percent of the positive electrode, the positive electroactive material including,
a first electroactive material including a lithium nickel manganese cobalt oxide (NMC), a lithium nickel manganese cobalt aluminum oxide (NMCA), a lithiated nickel cobalt aluminate (NCA), or a combination thereof, the first electroactive material having a nickel content of greater than or equal to about 60 mole percent,
a second electroactive material including a phosphate-containing positive electroactive material, and
a third electroactive material including a lithium manganese oxide (LMO), and
a polymeric binder;
a negative electrode including a negative electroactive material;
a polymeric separator between the negative electrode and the positive electrode; and
an electrolyte.

16. The electrochemical cell of claim 15, wherein the electrolyte includes,
a solvent selected from the group consisting of: ethylene carbonate (EC), ethylmethyl carbonate (EMC), diethyl carbonate (DEC), dimethyl carbonate (DMC), vinylene carbonate (VC), fluoroethylene carbonate FEC), and combinations thereof, and
a lithium salt selected from the group consisting of: lithium hexafluorophosphate (LiPF₆), lithium tetrafluoroborate (LiBF₄), lithium bis(fluorosulfonyl)imide (LiFSI), lithium bis(trifluoromethanesulfonyl)imide LiTFSI, lithium bis(oxolato)borate (LiBOB), and combinations thereof.

17. The electrochemical cell of claim 15, wherein
the positive electrode defines a plurality of pores, a portion of the electrolyte being in at least a portion of the plurality of pores, and
a porosity of the positive electrode is greater than or equal to about 20 volume percent to less than or equal to about 40 volume percent.

18. The electrochemical cell of claim 15, wherein the electrochemical cell is configured to have a discharge capacity retention of greater than or equal to about 90%.

19. A method of manufacturing an electrode, the method comprising:
preparing a slurry, the slurry including a positive electroactive material, an electrically-conductive material, and a polymer binder solution, the positive electroactive material including a first electroactive material, a second electroactive material, and a third electroactive material, the first electroactive material including a lithium nickel manganese cobalt oxide (NMC), a lithium nickel manganese cobalt aluminum oxide (NMCA), a lithiated nickel cobalt aluminate (NCA), or a combination thereof, the first electroactive material having a nickel content of greater than or equal to about 60 mole percent, the second electroactive material including a phosphate-containing positive electroactive material, and the third electroactive material including a lithium manganese oxide (LMO);
casting the slurry onto a substrate; and
drying the slurry to form electrode.

20. The method of claim 19, wherein the slurry has solids content of greater than or equal to about 65 weight percent.
